(19) United States
(12) Patent Application Publication
(10) Pub. No.: US 2018/0137121 A1
(43) Pub. Date: May 17, 2018

(54) CONTENT IDENTIFICATION BASED ON DYNAMIC GROUP PROFILES

(71) Applicant: Amazon Technologies, Inc., Reno, NV (US)

(72) Inventor: Tarun Agarwal, Seattle, WA (US)

(73) Assignee: Amazon Technologies, Inc., Reno, NV (US)

(21) Appl. No.: 14/147,002

(22) Filed: Jan. 3, 2014

(51) Int. Cl. G06F 17/30

(52) U.S. Cl. CPC G06F 17/30029

(57) ABSTRACT

The present disclosure relates to content identification based on dynamic formation of group profiles. The group profile can be associated with some organization criteria, such as physical location, temporal attributes, etc., and can be configured with various preferences and restrictions. Subsequent to the initialization of the group profile(s), individual users can be associated with the group. Based on the addition (or subtraction) of users, the established group profiles are updated or modified according to one or more attributes of the individual profiles of the users associated with the group. Content of interest to the group can be identified using the group profile information. The identified content can also be provided to the individual users associated with the group. The group profile can be updated based on group membership change or feedback to identified content, and additional or alternative content recommendations can be provided.

### BACKGROUND

Various computer-implemented methods and systems are used by media providers to help users locate content of interest. These systems and methods typically are tailored to serve single users. For example, using an electronic recommendation system, a movie content provider may identify movies of interest or recommend movies to an individual user. Such single user recommendation systems are often based on individual user profiles that include various attributes related to content, such as interest levels in different categories of content, ratings, previous content access and the like. Typically, the electronic recommendation systems used by media providers identify or recommend content items to individual users by implementing user profile data in the context of collaborative filtering approaches, content based filtering approaches, or their combination.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure.

FIG. 1 is a block diagram illustrating a networked computer environment in which a content identification system communicates with user computing devices, content providers and customer networks according to one embodiment.

FIG. 2A is a block diagram illustrating a user computing device initiating a request to register or access a user profile in the networked computer environment of FIG. 1, followed by the content identification system transmitting data of the user profile to the user computing device.

FIG. 2B is a block diagram illustrating a customer initiating a request to log in a group profile in the networked computer environment of FIG. 1, followed by the content identification system transmitting data of the group profile to the customer.

FIG. 2C is a block diagram illustrating processing of requests for identification of content in the networked computer environment of FIG. 1.

FIG. 2D is a block diagram illustrating collecting feedback to content identification results provided in response to requests for identification of content.

FIG. 3 is a flow diagram of an illustrative group profile creation process implemented by the content identification system.

FIG. 4 is a flow diagram of an illustrative content identification process implemented by the content identification system.

### DETAILED DESCRIPTION

Generally described, the present disclosure corresponds to methods and systems for the identification of content of interest for a group of users based on a group profile. More specifically, aspects of the present disclosure relate to content identification based on dynamic formation of group profiles. A group of users are provided or consume content in various group settings. The content is requested from one or more content providers by a customer of a recommendation service such that the customer controls, facilitates, or contributes to the identification and delivery of the content to the group of users. For example, a customer, such as a coffee shop, of a recommendation service may need to identify appropriate background music for broadcasting that is most conducive to the specific users present in the shop at any particular time.

In accordance with an illustrative embodiment, a content identification system obtains requests from a customer for establishing one or more group profile(s). Illustratively, the customer can provide, or otherwise be associated with, a physical or virtual network that can be accessed by a group of users. The collection of the user devices, and possibly individual users of the user devices, can be generally referred to as a customer network. The group profile for a customer network can be associated with organization criteria, such as physical location, temporal attributes, etc., that help form the selection of which user devices are considered to be part of a customer network at any particular time. Additionally, the group profile can be further configured with various preferences and restrictions that may influence the recommendations of content provided to the users associated with the customer network.

Subsequent to the initialization of the group profile(s), individual user devices can be associated with the group, such as by satisfying group organization criteria, requesting membership, detection by or registering with the customer network and the like. In addition to the identification of user devices (and users) as being associated with customer networks, aspects about the user devices (and users), such as content preferences, are used in the updating of recommendations based on the set of users making up the customer network. In one embodiment, based on the addition (or subtraction) of users, the established group profiles are updated or modified according to one or more attributes of the individual profiles of the users associated with the group. Accordingly, aspects of the group profile and the information associated with the group profile will be dynamic in nature in accordance with the variation of the user devices associated with the customer network.

Using the group profile information, the content identification system can identify content of interest responsive to the request from the customer of the service and corresponding to the customer network. Illustratively, the content can be delivered, or caused to be delivered, to one or more devices identified with the customer, such as for broadcasting. Additionally, identified content can also be provided to the specific individual users devices associated with the customer network. As the membership of the customer network changes, such as based on a re-evaluation or update of organization criteria, the content identification system can update the attributes associated with the group profile and provide additional or alternative content recommendations responsive to additional requests from a customer or without requiring additional requests.

For purposes of illustration, the systems and processes disclosed herein are described primarily in the context of a content identification system that provides user devices, users of the user devices and customers with access to user profiles, group profiles, and identification of media items. For purposes of illustration, embodiments or examples referencing user devices or users may be considered applicable to either user devices, users associated with one or more user's devices, or both, regardless of whether references to user devices or users are used in the particular example or description. As will be apparent, however, the disclosed systems and processes may also be used in other types of systems, and can be used to identify other content items, such as but not limited to merchandise, network sites, news articles, blogs, podcasts, travel destinations, service providers, other users (e.g., as potential friends in a social network), events, discussion boards, photos and other images, videos, tagged items, advertisements, and user-generated lists of items. In addition, the disclosed systems and processes need not be implemented as part of, or in conjunction with, a network site such as a web site.

The term “item” is used interchangeably herein to refer to an item itself (e.g., a particular media, product, service, bundle of products or services or any combination thereof) and to its description or representation in a computer system. As will be apparent from the context in which it is used, the term is also sometimes used herein to refer only to the item itself or only to its representation in a computer system.

### Overview of an Example Embodiment

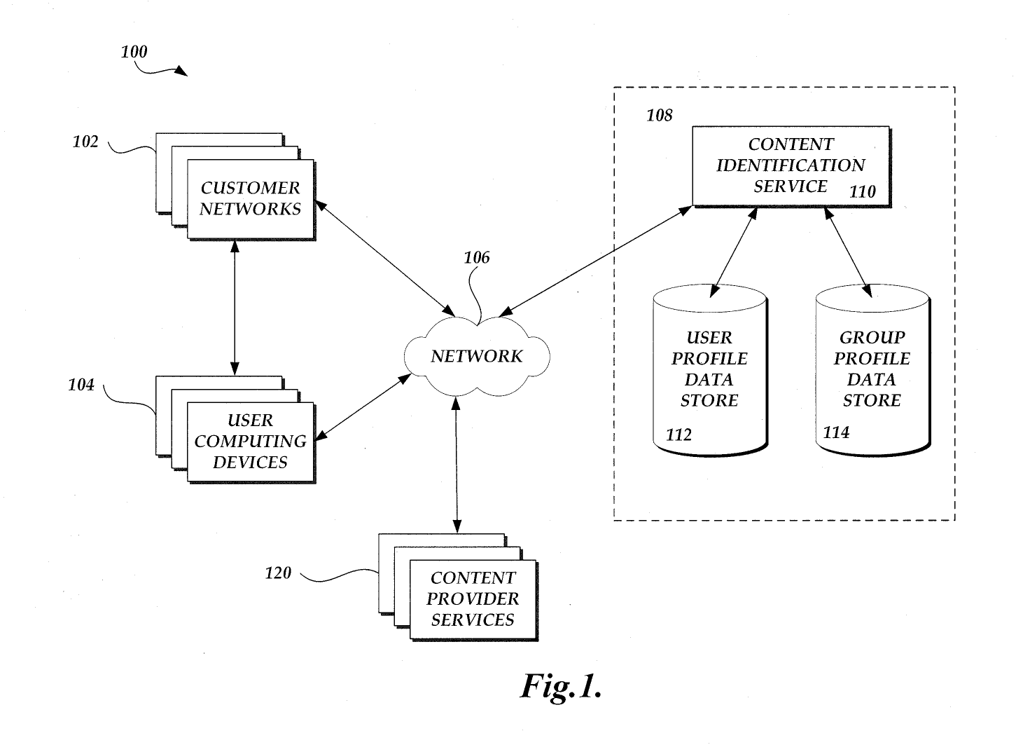

FIG. 1 illustrates an embodiment of a networked computer environment 100 including a content identification system 108 that can implement the features described herein. In one aspect, the content identification system 108 can generally provide a network application, such as a network application or network site, which performs and provides the content identification functions described herein, including creating, accessing, retrieving, modifying, or updating user and group profiles, identifying content items based on a group profile, individual user device or user profile(s) or a customer request, and providing content identification results to the customer (or a device designated by the customer), to users (or users devices) or to content providers. In another aspect, the content identification system 108 may be configured to process user's or customer's behavioral data or relational data between or among any combinations of content items, users, customers, interests, preferences and the like, to generate user profile or group profile information. In some embodiments, the content identification system 108 is associated with a network or Internet-based media content provider.

The content identification system 108 can correspond to any system capable of performing the processes described herein. In the depicted embodiment, the content identification system 108 includes several components that can be implemented in hardware or in software executed in hardware. For example, in the illustrated embodiment of FIG. 1, the content identification system 108 includes a user profile data store 112, a group profile data store 114, and a content identification service 110, configured to execute the methods for content identification described herein. The user profile data store 112 generally stores and provides access to user profiles associated with individual users. Similarly, the group profile data store 114 generally stores and provides access to group profiles associated with customers and users' devices that have been associated with a particular customer network. Both data stores can also store and provide access to auxiliary information such as relational data between or among any combinations of content items, users, customers, interests, preferences and the like. Although the user profile data store 112, a group profile data store 114, and a content identification service 110 are identified in FIG. 1 as single data stores, one skilled in the relevant art will appreciate that the data stores may be implemented by two or more components and in a distributed manner. Moreover, the data stores may be remote or local to the content identification service 110. Accordingly, the depictions of the data stores are illustrative in nature.

The user profile data store 112 can generally include any repository, database, or information storage system that can store information associated with users. For example, a user profile stored in the user profile data store 112 can include user account information, user priority, user billing plan, user group preferences, user interests, user content ownership information, user content preferences, user content access history, user demographic information, social network connections, geolocation information, user device information, user content identification history, queued or saved content items, or the like. The user profile data store 112 can also store information including relational data between or among any combinations of content items, users, customers, interests, preferences and the like.

The group profile data store 114 can generally include any repository, database, or information storage system embodied in non-transitory computer readable media that can store information of and relating to group profiles associated with customers. For example, a group profile stored in the group profile data store 114 can include group organization criteria, group device information, participating users, selected content identification models, group billing configurations, group interests, customer content ownership information, group content preferences, group restrictions, or the like. In some embodiments, a group profile can include information equivalent to those included in user profiles, so as to make group profiles compatible with existing content identification methods or systems tailored toward individual users. Similar to the user profile data store 112, the group profile data store 114 can store information including relational data between or among any combinations of content items, users, customers, interests, preferences and the like.

The content identification service 110 may identify a content item in response to a request from a customer, a user, or an administrator associated with the content identification system 108. In some embodiments, the content identification service 110 is communicatively connected to the user profile data store 112 and the group profile data store 114, for creating, accessing, retrieving, modifying, or updating user profiles and/or group profiles. The content identification service 110 can identify content items based on a corresponding group profile or a request for content identification from a customer.

In some embodiments, the content identification service 110 may identify a content item automatically without receiving a user, customer, or administrator request. In some cases, the content identification service 110 may identify a content item to a user, customer, or content provider in response to a passage of time since a previous identification. In some cases, the content identification service 110 may explicitly identify a content item. Alternatively, the content identification service 110 may implicitly identify a particular content item of the content type by presenting the ranking of a content type to a user or customer. For example, by presenting the downloading ranking of country music to a customer, the identification service 110 implicitly identifies a piece of country music ranked the highest on the downloading ranking (e.g., has been downloaded the most within a time period).

The networked computer environment 100 may also include further components that may not be depicted in FIG. 1. For example, the content identification system 108 and the content identification service 110 may be provided by various computing systems or devices implementing computer-executable instructions, such as network servers, application servers, database servers, combinations of the same, or the like, configured to receive and respond to requests from customer networks 102, user computing devices 104, or content provider services 120 via network 106.

The network 106 may include any system for allowing multiple computing devices to communicate with each other. For example, the network 106 can be a Local Area Network (LAN), a Wide Area Network (WAN), a wireless network, a satellite network, a cable network, a cellular network, the Internet, combinations of the same, or the like. Additionally, it should be noted that in some embodiments, the content identification service 110 and any other components of the content identification system 108 may be executed by one more virtual machines implemented in a hosted computing environment. The hosted computing environment may include one or more rapidly provisioned and released computing resources, which computing resources may include computing, networking and/or storage devices. A hosted computing environment may also be referred to as a cloud-computing environment

User computing devices 104 can be used by users to communicate with customer networks 102, content identification system 108, or content provider services 120. The user computing devices 104 can include any computing system or device that can facilitate such communications. These computing devices can generally include, without limitation, wireless mobile devices (e.g., smart phones, PDAs, tablets, or the like), desktops, laptops, video game platforms, electronic book readers, television set-top boxes, televisions (e.g., internet TVs), and computerized appliances. Further, the user computing devices 104 can include one or more hardware processors capable of implementing any type of software or application (such as a browser or a mobile media application) that can facilitate such communications.

Customer networks 102 can be associated with individual customers and are subject to their control or management. Individual customer networks 102 can also be accessed by a group of users associated with them. The customer networks 102 can include any devices, systems, or protocols that facilitate multiple computing devices to communicate with each other. For example, the customer networks 102 can be a Local Area Network (LAN), a Wide Area Network (WAN), a wireless network, a satellite network, a cable network, a cellular network, the Internet, combinations of the same, or the like. Further, the devices associated with the customer networks 102 can include any type of software (such as a browser or a mobile media application) that can facilitate such communications. Additionally, one or more components of the customer networks 102 can be implemented in virtual networks hosted by physical computing devices. The customer networks 102 can also include any computing system or device that can interact with associated customers or users, or can communicate with non-associated user computing devices 104, content identification system 108, or content provider services 120. These computing devices can generally include, without limitation, wireless mobile devices (e.g., smart phones, PDAs, tablets, or the like), desktops, laptops, video game platforms, electronic book readers, television set-top boxes, televisions (e.g., internet TVs), and computerized appliances.

The content provider services 120 can be associated with individual content providers. In some embodiments, the content provider services 120 can be communicatively connected to the content identification service 110 and provide information including relational data between or among any combinations of content items, users, customers, interests, preferences and the like. In some embodiments, the content provider services 120 can provide content items to customers or users via the network 106. The content provider services 120 may be provided and/or implemented by various computing systems or devices that can communicate with the content identification system 108, the customer networks 102, or the user computing devices 104. The content provider services 120 can utilize any repository, database, or information storage system embodied in non-transitory computer-readable media that can store content items and the relational data described above. Further, the various computing systems or devices providing the content provider services 120 can implement any type of software that can facilitate the communications described above.

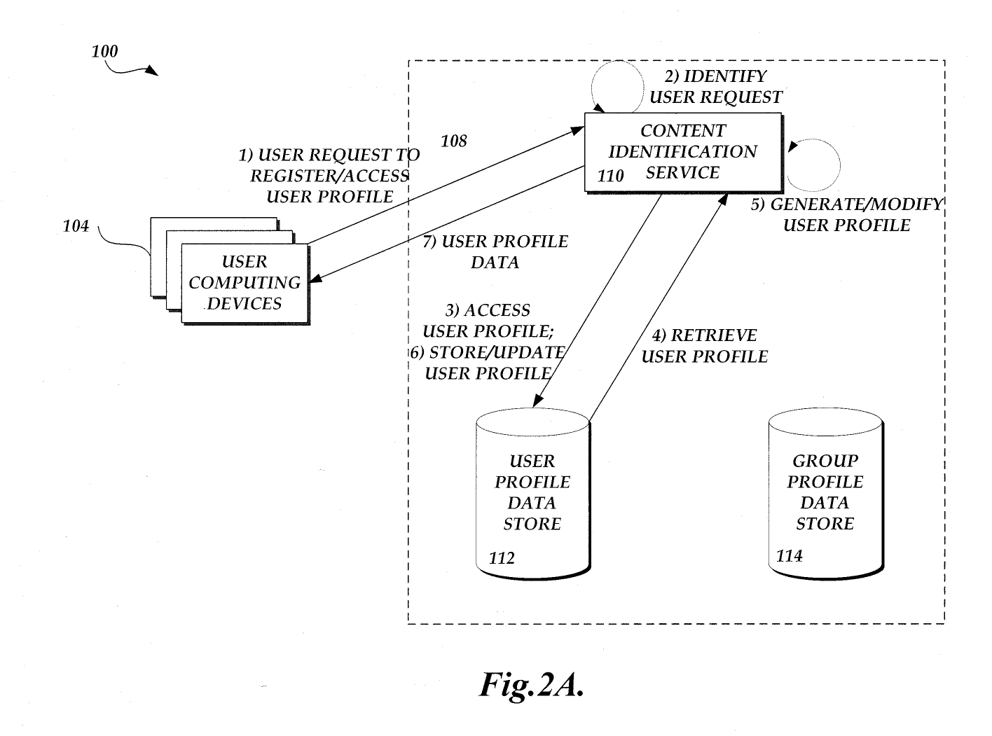

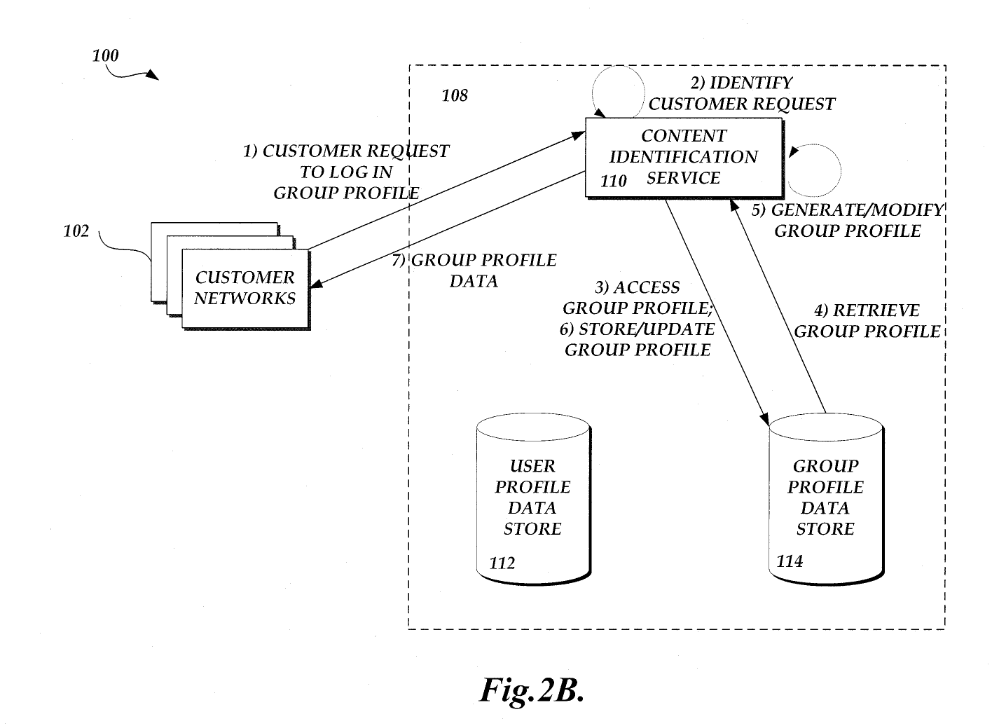

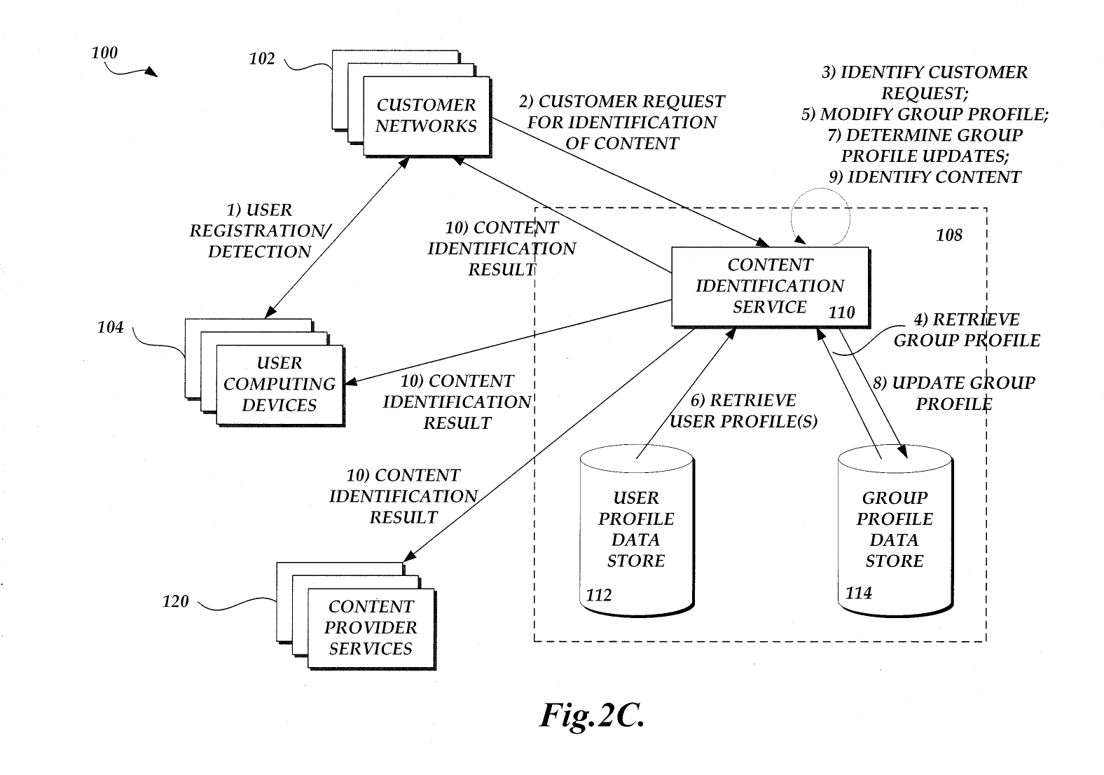

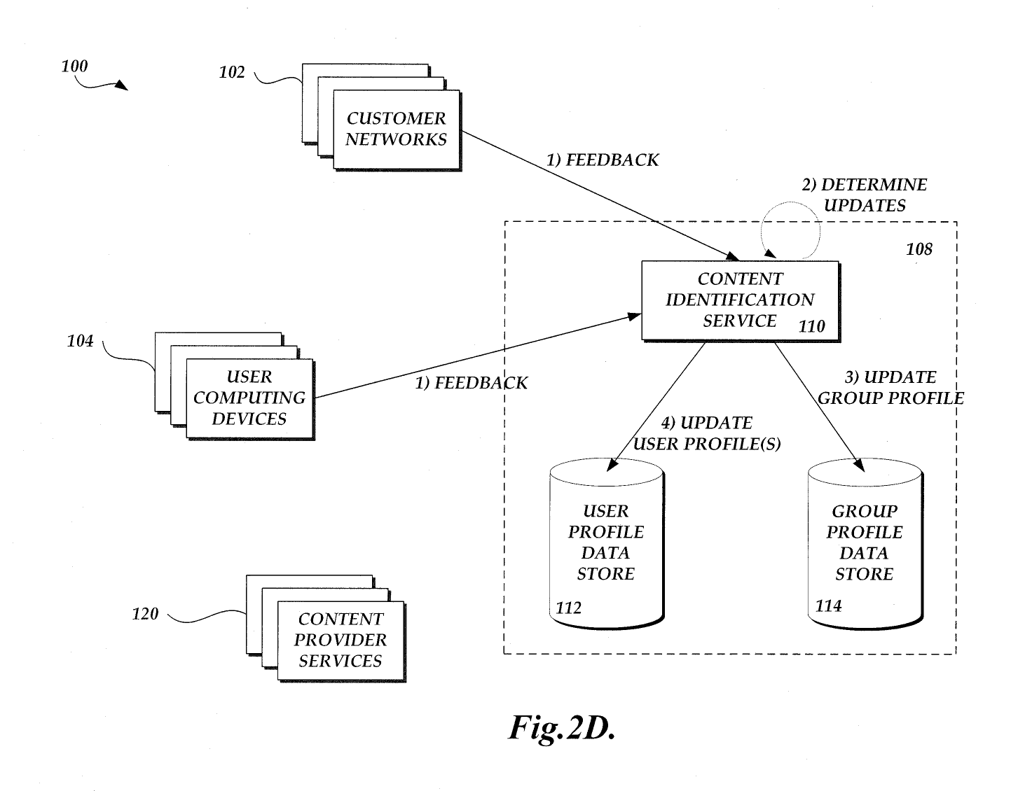

FIG. 2A block diagram illustrating a user computing device initiating a request to register or access a user profile in the networked computer environment 100 of FIG. 1, followed by the content identification system transmitting data of the user profile to the user computing device 104. As depicted in FIG. 2A, at (1), a user, via a user computing device 104, initiates a request to register or access a user profile. Illustratively, the user request can include any number of different requests, including, but not limited to, a request to create, modify, or restrict access to the user profile. Additional types of requests are envisioned without departing from the spirit and scope of the present description.

The user request can be accomplished by simply accessing a user interface provided by the content identification service 110, such as a network page, or by entering user login information. Upon identifying the user request at (2), the content identification service 110 can process the request in a variety of ways. For example, if the user request includes a request to modify an existing user profile, the content identification service 110 can request access, at (3), to the user profile stored in the user profile data store 112. At (4), the content identification service 110 retrieves data of the user profile. At (5), the content identification service 110 modifies the user profile as requested by the user. At (6), the content identification service 110 updates the user profile stored in the user profile data store 112. At (7), the content identification service 110 transmits data of the modified user profile to the user, via the user computing device 104.

Data included in user profiles may be obtained by requesting information from users. Alternatively, or in addition, such information may be obtained by mining users' behavioral data, such as purchasing or accessing content items, rating content items, providing reviews on content items, adding content items to wish list, recommending content items, tagging content items, searching for content items and the like. For instance, if a user downloads a video that includes interviews of a particular movie's cast members, the content identification system 108 may determine that the user owns a copy of the movie. Further, the content identification system 108 may request that the user confirm that the user owns a copy of the particular movie or request that the user identify what episode or version of the movie the user owns.

FIG. 2B is a block diagram illustrating a customer initiating a request to log in a group profile in the networked computer environment 100 of FIG. 1, followed by the content identification system 108 transmitting data of the group profile to the customer. As depicted in FIG. 2B, at (1), a customer, via a client associated with the customer network 102, initiates a request, via a computing device, to log in a group profile with the content identification system 108. Illustratively, the customer request can include any number of different requests, including, but not limited to, a request to create, modify, or update the group profile. Additional types of requests are envisioned without departing from the spirit and scope of the present description.

The customer request can be accomplished by simply accessing a customer interface provided by the content identification service 110, such as a network page, or by entering customer login information. Upon identifying the customer request at (2), the content identification service 110 can process the request in a variety of ways. For example, if the customer request includes a request to modify an existing group profile, the content identification service 110 can request access, at (3), to the group profile stored in the group profile data store 114. At (4), the content identification service 110 retrieves data of the group profile. At (5), the content identification service 110 modifies the group profile as requested by the customer. At (6), the content identification service 110 updates the group profile stored in the group profile data store 114. At (7), the content identification service 110 transmits data of the modified group profile to the customer, via the customer network 102.

As a another example, if the customer request includes a request to create a new group profile, the content identification service 110 can collect information to be included in the new group profile, such as group organization criteria, selected content identification models, group billing configurations, group restrictions, or the like, from the customer request. In some embodiments, a group profile can include information equivalent to those included in user profiles, so as to make group profiles compatible with existing content identification methods or systems tailored toward individual users. Such embodiments may be implemented, for example, when the selected content identification model of the group profile specifies a collaborative filtering algorithm that typically makes automatic predictions about content items of interest to a user by collecting preferences or taste information from many users. In these embodiments, because the group profile includes information equivalent to those included in user profiles, content items of interest to the group can be predicted using the specified collaborative filtering algorithm, essentially treating the group profile as a user profile for collaborative filtering purposes.

Alternatively, or in addition, the content identification service 110 can request that the customer provide information to be included in the group profile. Further, such information may be obtained by mining customer's or group-participating users' behavioral data, or relational data between or among any combinations of content items, users, customers, interests, preferences and the like. At (5), the content identification service 110 generates the new group profile. At (6), the content identification service 110 stores the new group profile in the group profile data store 114. At (7), the content identification service 110 transmits data of the new group profile to the customer, via the customer network 102.

In addition to creating, accessing, retrieving, and/or updating the requested user profile or group profile, the content identification service 110 may retrieve information including relational data between or among any combinations of content items, users, customers, interests, preferences and the like, as described previously, that are stored in the user profile data store 112, the group profile data store 114, or provided by the content provider services 120. Such information can be used to facilitate the fulfillment of user or customer requests, as described with respect to FIG. 2A and 2B.

FIG. 2C is a block diagram illustrating processing of requests for identification of content in the networked computer environment 100 of FIG. 1. As depicted in FIG. 2C, initially at (1), users can register with a customer network 102 as a way to join the customer network 102 and to participate in a corresponding group profile. It should be noted that a user may establish or otherwise be associated with multiple customer networks 102. Further, multiple group profiles can be associated with a same customer network 102 suiting needs of different situations. For example, a customer, such as a coffee shop may establish optimized customer network and group profile combinations, respectively, for identifying appropriate background music to users present in the shop, for identifying appropriate media to present on a large screen TV in the dining area, for sending appropriate promotional content to users' personal computing devices, or to accommodate the needs of a birthday celebration. It should also be noted that a user may simultaneously join multiple customer networks 102 and/or participate in more than one group profiles associated with one or more customer network of the multiple networks.

Various techniques can be used to accomplish the registration of users on a customer network. For example, in some embodiments, a user is associated with a user computing device 104. It should be noted, however, that each user need not have his or her own user computing device. One or more users can share one or more devices, and in some embodiments, one or more users need not interact with a user computing device. A registering user can use her device 104 to initiate a registration on the customer network 102. Alternatively, a user's computing device can automatically be detected by the customer network 102 (e.g., using mobile media applications, Bluetooth, near field communications (NFC), RFID, wireless LAN, the like, or combinations thereof), and the associated user can be added as a member of the customer network 102. Optionally, users can be required to accept a group invitation before they can be added to a corresponding group profile associated with the customer network.

Users can be recognized based on physical characteristics (e.g., by facial recognition, fingerprint scanning, iris recognition, or other biometric identification) and added to, or associated with, a customer network 102. In one embodiment, a camera on a user's smart phone can use voice or facial recognition to register the user on a customer network. In another embodiment, a camera connected to a multimedia device (e.g., video game console) can be used to detect nearby users visually or via audio and add them to a customer network. Identification, such as facial recognition, can be provided by a user computing device 104 or by transmitting appropriate information (e.g., a snapshot or voice sample) via a customer network 102 to the content identification service 110. Identified users can be automatically added to a group profile corresponding to the customer network or can be required to accept an invitation as described above.

In still other embodiments, a customer can invite users to participate in a customer network and a corresponding group profile by sending digital invitations. For example, the digital invitations can be sent by email, instant message, text message, network-based service or the like. Recipient users can then accept the invitation to join the customer network and the corresponding group profile.

With continued reference to FIG. 2C, at (2), the customer, via the customer network 102, sends a request for identification of content for an associated group profile to the content identification service 110. Illustratively, the customer request can include any number of different requests, including, but not limited to, a request to create, modify, or update the group profile, a request for content identification to be provided to the customer, participating users, or content providers. Additional types of requests are envisioned without departing from the spirit and scope of the present description.

The customer request for content identification can be accomplished by simply accessing a customer interface provided by the content identification service 110, such as a network page. Upon identifying the customer request at (3), the content identification service 110 can process the request in a variety of ways. For example, if the customer request includes a first request to modify an existing group profile and a second request for identification of content to be provided to the customer based on the group profile, the content identification service 110 can request access to the group profile stored in the group profile data store 114 and retrieve data of the group profile at (4). At (5), the content identification service 110 modifies the group profile as requested by the customer. At (6), the content identification service 110 requests access to participating users' profiles stored in the user profile data store 112 and retrieve data of the user profiles. At (7), the content identification service 110 determines updates for the modified group profile. At (8), the content identification service 110 updates the group profile stored in the group profile data store 114. At (9), the content identification service 110 identifies content based on the updated group profile. At (10), the content identification service 110 transmits content identification result to the customer, via the customer network 104.

In addition to retrieving the requested user profile or group profile, the content identification service 110 may retrieve information including relational data between or among any combinations of content items, users, customers, interests, preferences and the like, as described previously, that are stored in the user profile data store 112, the group profile data store 114, or provided by the content provider services 120. Such information can be used to facilitate the fulfillment of the customer request for identification of content, as described with respect to FIG. 2C.

In another embodiment, the content identification service 110 can repeat portions of the interaction illustrated in FIG. 2C based on criteria determining whether the membership to the group profile should be updated. For example, in one embodiment, the determination of which users are to be included in the group profile may be time-based such that the content identification service 110 will update the identification of users after the expiration of time criteria. In another embodiment, the determination of which users are to be included in the group profile is event-based such that the content identification service 110 can update the group based on determination of one or more events. For example, the content identification service 110 can update the group profile based on detection of a new user device or payment of services.

FIG. 2D is a block diagram illustrating collecting feedback to content identification results provide in response to requests for identification of content. As depicted in FIG. 2D, at (1), feedback to content identification result is provided to the content identification service 110 by a customer or user. For example, a customer can provide feedback by purchasing, accessing, adopting, or presenting an identified content item, or otherwise indicate whether the customer favor or disfavor the identified content item. Users who received or perceived the identified the content can also provide feedback by purchasing, accessing, rating, reviewing an identified content item, or otherwise indicate whether the user(s) favor or disfavor the identified content item.

After receiving the feedback, at (2), the content identification service determines updates for the group profile or user profiles of participating users that formed the basis for determining the content identification result. For example, feedback from a customer can be used to adjust the group organization criteria, participating users, selected content identification models, group billing configurations, group interests, customer content ownership information, group content preferences, or group restrictions of the group profile; similarly, feedback from a user can be used to adjust applicable information of the user's profile.

Accordingly, the content identification service 110 updates the group profile stored in the group profile data store 114 at (3). Alternatively, the content identification service 110 updates the user profiles stored in the user profile data store 112 at (4). In some embodiments, the content identification service 110 may update corresponding group profile or user profiles without feedback from the customer or participating users. The content identification service 110 may update the group profile or user profiles in response to a passage of time since a previous identification of content to the customer or users.

### Example Group Profile Creation Process

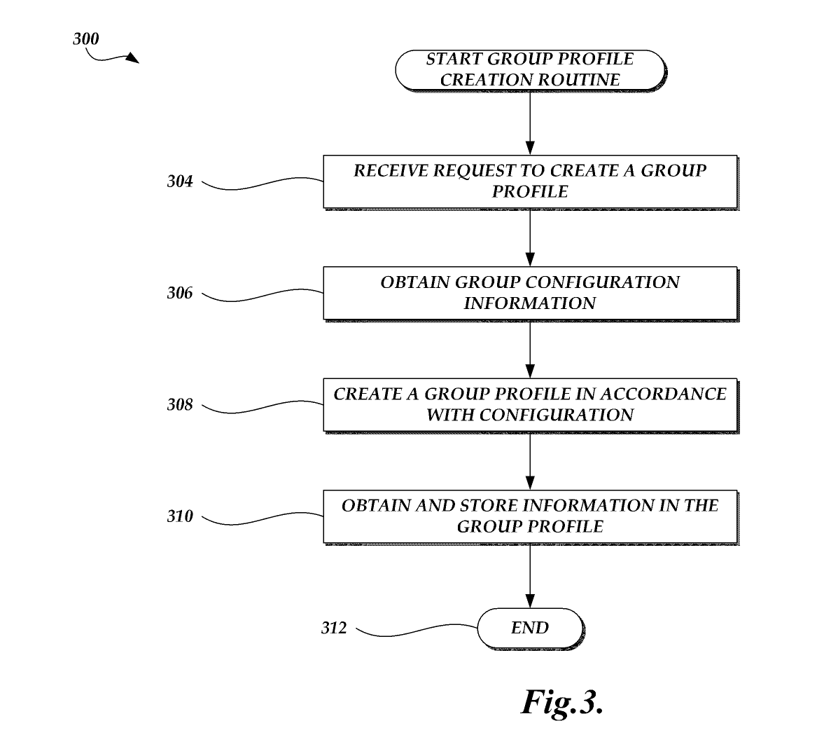

FIG. 3 is a flow diagram of an illustrative group profile creation process 300 implemented by the content identification service 110 of the content identification system 108 in one embodiment. Process 300 begins at block 304, where a request to create a group profile is received. The request may be received in a form of an http request or other forms of communication, generated by a customer accessing a customer interface provided by the content identification service 110, such as a network page. It should be noted that the customer requesting the creation of a group profile may also be a user of the group profile. For example, a group of family members subscribing to certain family media plan may have a group profile created to fit their needs. The group profile may be created, for example, in response to a request sent by one of the parents to create the group profile. At block 306, group configuration information is obtained. The request itself may specify the group profile configuration information. For example, the request may specify the type of attributes, features, or information to be included in the group profile. In some embodiments, the group profile configuration is determined by a content identification technique employed. Various existing content identification techniques can be used in this regard. For example, user activity with respect to an electronic catalog can be monitored and recorded. The recorded information can be mined to detect associations (e.g., behavioral associations) among items in the catalog. For example, related techniques are described in pending, and commonly owned, U.S. patent application Ser. No. 09/821,712, entitled “Use of Product Viewing Histories of Users to Identify Related Products,” and filed Mar. 29, 2001, the complete disclosure of which is hereby incorporated by reference. Other identification techniques can also be applied. The request can also specify criteria for determining participating users of the group profile and for determining the timing or frequency to update the group makeup.

At block 308, a group profile is created in accordance with the group configuration information described above. In some embodiments, a group profile can include types of information equivalent to those included in user profiles, so as to make group profiles compatible with existing content identification methods or systems tailored toward individual users.

At block 310, information to be included in the group profile is obtained and stored. Group profile information may include group organization criteria, group device information, participating users, selected content identification models, group billing configurations, group interests, customer content ownership information, group content preferences, group restrictions, or the like.

The group profile information may indicate the needs, preferences, or restrictions of the customer associated with the group, it may also reflect the social-setting of the group profile. For example, group organization criteria may include event-based criteria, theme based criteria, location-based criteria, and time-based criteria; selected content identification models may specify one or more methods or systems for content identification that are applicable to the group profile; group billing configurations may indicate who would be paying for content in different situations, group interests or content preferences may indicate what kind of content are welcomed for the group, group restrictions may forbid certain content items, etc.

All or part of such information can be specified in the request to create the group profile, can be obtained by requesting such information from the associated customer, or can be derived by mining the customer's and/or participating users' behavioral data, and/or relational data between or among any combinations of content items, users, customers, interests, preferences and the like. The group profile creation routine ends at block 312.

### Example Content Identification Process

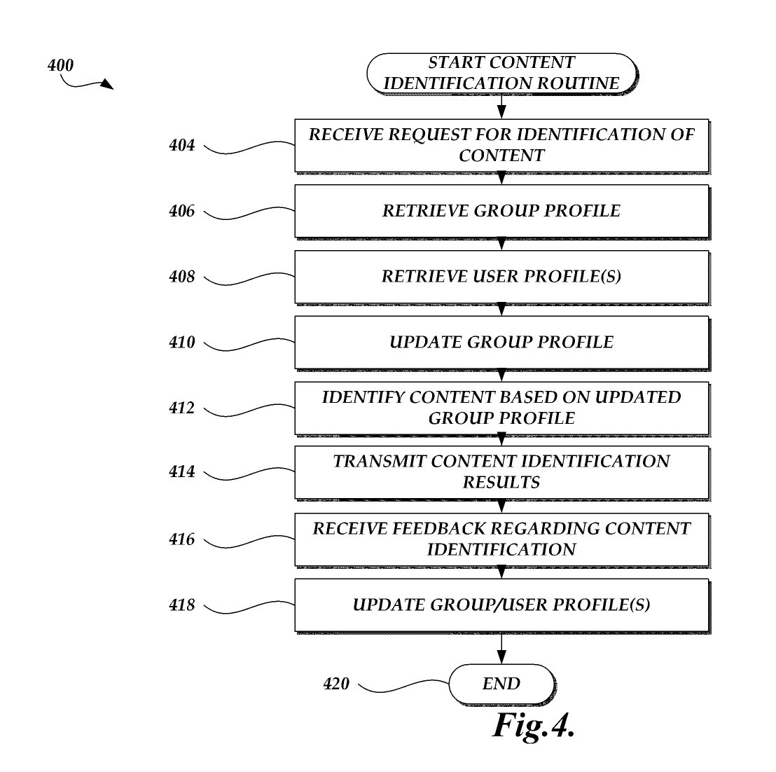

FIG. 4 is a flow diagram of an illustrative content identification process 400 implemented by the content identification service 110 of the content identification system 108, in accordance with one embodiment. Process 400 begins at block 404, where a request for identification of content is received. The request can specify a group profile associated with a group for which content identification is requested. The request can also specify information and mechanisms for modifying and/or updating the specified group profile. For example, the request can indicate a change in group organization criteria to reflect a shift in the theme of a coffee shop. As another example, the request may include information for modifying the group device information to reflect a change from a stereo sound system to a surround sound system.

Further, the request can specify the recipient(s) of content identification result. For example, the request can specify that the content identification result be transmitted to an associated customer and participating users, but not to content providers. Still further, the request may specify what types of information in the participating users' profiles will be a basis for updating the group profile.

The specified group profile is retrieved at block 406. In some embodiments, only relevant portions of the group profile are retrieved. Such relevance determination can be based on information included in the request. The group profile can be modified based on information specified by the request. Participating users of the group profile can be determined from information included in the group profile, or, can be specified by the request.

At block 408, user profiles of participating users of the group profile are retrieved. Similar to the group profile retrieval, in some embodiments, only relevant portions of the user profiles are retrieved. Such relevance determination can be based on information included in the request or based on information included in the group profile. It also should be noted that, some user profiles may not be retrieved with respect to the specified group profile even if they are associated with participating users of the group profile. Such access restrictions may be indicated by or derived from information included in the user profiles. For example, a user may have opted out of group-based content identification services, or, a user may have decided to be a pure recipient and not to contribute to the group-based content identification. Such choices can be indicated by the user account information or user billing plan. As another example, a user may have limited user profile access only to groups established by certain customers, or may have blacklisted other group profiles. Such information can be indicated by the user group preferences.

At block 410, updates are determined for and applied to the group profile. Retrieved user profiles, in combination with relational data between or among any combinations of content items, users, customers, interests, preferences and the like, can be used to determine updates for the group profile. Information included in the group profile, the request, or retrieved user profiles can also be used to facilitate weighting, reordering, prioritizing, filtering, or other modifications that may be utilized in determining updates. For example, group interests included in the group profile may be used to filter out user profiles that do not indicate user interests that overlap group interests. As another example, user priority information included in user profiles can indicate a relative weight of an individual user profile in the group. As a further example, the group billing configurations of the group profile may indicate that the group profile may be overridden based on receipt of a request by specific users, such as a master user. In another example, the group profile may indicate that that the group profile may be overridden by payment of a specific fee, or other compensation, by a user. In these embodiments, the content identification service 110 can limit the ability for specific users to override, subject to organization criteria or other information included in the group profile or the request. Determined updates are then applied to the group profile, thus the group profile is updated for content identification.

At block 412, content item(s) are identified based on the updated group profile. Besides explicit specifications in the request or in the group profile to identify a particular type of content, such information can also be derived. For example, if the group device is a surround sound audio system and the recipient is the customer associated with the group, then content items to be identified should be audio items. In some embodiments, the updated group profile includes information equivalent to those included in user profiles, so that the group profile is compatible with existing content identification methods or systems tailored toward individual users. Accordingly, the content identification system 108 may obtain content identification results thereby—essentially treating the group profile as a user profile.

Various existing content identification techniques can be used in this regard. For example, user activity with respect to an electronic catalog can be monitored and recorded. The recorded information can be mined to detect associations (e.g., behavioral associations) among items in the catalog. For example, related techniques are described in pending, and commonly owned, U.S. patent application Ser. No. 09/821,712, entitled “Use of Product Viewing Histories of Users to Identify Related Products,” and filed Mar. 29, 2001, the complete disclosures of which are hereby incorporated by reference. Other identification techniques can also be applied.

In other embodiments, the group profile may include a weighted combination of the lists of content items previously identified, queued, saved, or wish-listed for individual participating users of the group. Content item(s) can be identified therefrom for the group profile. As another example, the group profile may include a weighted aggregation of applicable information included within retrieved user profiles, which in combination with relational data between or among proper combinations of content items, users, customers, interests, preferences and the like can be used to identify content for the group.

At block 414, content identification results are transmitted to recipient(s) specified in the request. It should be noted that the specified recipient(s) can be a contributing factor to the group profile updating or content identification steps. Content identification results can be an indication, list, or other information of content item(s), or, can be the content item(s) themselves. For example, if a customer is a specified recipient, an identified content item such as a piece of country music in digital format, can be streamed to one of the customer's computing devices and presented by the customer's designated surround sound audio system that is connected to the computing device. As another example, if a participating user is a specified recipient, an identified content item such as a promotional advertisement in digital format, can be downloaded to the user's smartphone.

At block 416, feedback(s) regarding the content identification result are received. Feedbacks can come from a customer or a user. For example, a customer can provide feedback by purchasing, accessing, adopting, or presenting an identified content item, or otherwise indicate whether the customer favor or disfavor the identified content item. Participating users of a group can also provide feedback by purchasing, accessing, rating, reviewing an identified content item, or otherwise indicate whether the user favor or disfavor the identified content item.

After receiving the feedback, at block 418, updates are determined for and applied to the group profile and/or user profiles of participating users that formed the basis for determining the content identification result. For example, feedback from a customer can be used to adjust the group organization criteria, participating users, selected content identification models, group billing configurations, group interests, customer content ownership information, group content preferences, or group restrictions of the group profile; similarly, feedback from a user can be used to adjust applicable information of the user's profile. Relational data between or among any combinations of content items, users, customers, interests, preferences and the like can be used to facilitate these updates. The content identification routine ends at block 420.

Depending on the embodiment, certain acts, events, or functions of any of the algorithms described herein can be performed in a different sequence, can be added, merged, or left out altogether (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The elements of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” “involving,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope.

1. A computer-implemented method for identifying content of interest to a group of users, the computer-implemented method comprising:
under control of a hardware computing device configured with specific computer-executable instructions,
obtaining a request from a service customer for identification of content, the request indicating a group profile associated with a group of users, wherein the service customer is distinct from the group of users wherein the group profile was created by the service customer without identifying individual users of the group of users, and wherein the group profile includes information provided by the service customer;
identifying the group profile associated with the group of users;
automatically determining whether to add or remove a user from the group of users based on organizational criteria, wherein the organizational criteria include user online behavior;
in response to automatically determining to add or remove the user:
retrieving data related to a user profile associated with the user; and
updating the group profile based at least in part on the data related to the user profile;
identifying content based at least in part on the updated group profile, the identified content responsive to the request for identification of content;
obtaining feedback from the service customer in response to the identified content; and
updating the group profile based at least in part on the feedback.

2. The computer-implemented method of claim 1, wherein identifying content includes identifying content with respect to the group of users.

3. The computer-implemented method of claim 1, wherein identifying content includes identifying content with respect to at least one individual user of the group of users.

4. The computer-implemented method of claim 1, wherein obtaining feedback includes obtaining feedback with respect to the group of users.

5. The computer-implemented method of claim 1, wherein obtaining feedback includes obtaining feedback with respect to at least one individual user of the group.

6. The computer-implemented method of claim 1, wherein content includes media data.

7. The computer-implemented method of claim 1, wherein the request for identification of content indicates an organization criterion of the group.

8. A computer-implemented method comprising:
under control of a hardware computing device configured with specific computer-executable instructions,
obtaining a request from a service customer for identification of content, the request indicating a group profile associated with a group of users, wherein the service customer is distinct from the group of users wherein the group profile was created by the service customer without identifying individual users of the group of users, and wherein the group profile includes information provided by the service customer;
identifying the group profile associated with the group of users;
automatically determining whether to add or remove a user from the group of users based on organizational criteria, wherein the organizational criteria include user online behavior;
in response to automatically determining to add or remove the user:
retrieving data related to a user profile associated with the user; and
updating the group profile based at least in part on the data related to the user profile; and
identifying content based at least in part on the updated group profile and feedback from the service customer.

9. The computer-implemented method of claim 8, wherein updating the group profile includes updating the group profile based at least in part on the request for identification of content.

10. The computer-implemented method of claim 8, wherein the group profile was created based at least in part on a plurality of user profiles, wherein at least one user profile of the plurality of user profiles indicates a priority associated with the at least one user profile, and wherein updating the group profile is determined at least in part by the priority.

11. The computer-implemented method of claim 10, wherein updating the group profile includes overriding the group profile utilizing the at least one user profile indicating the priority.

12. The computer-implemented method of claim 10, wherein updating the group profile includes weighting individual user profiles of the plurality of user profiles based at least in part on the associated priority.

13. The computer-implemented method of claim 8, wherein identifying content includes causing downloading content to a computing device.

14. The computer-implemented method of claim 8, wherein identifying content includes causing streaming content to a computing device.

15. A system comprising:
one or more first storage devices, the one or more first storage devices operative to store and maintain user profile data associated with at least one user of a group of users;
one or more second storage devices, the one or more second storage devices operative to store and maintain group profile data associated with the group; and
a computing device including a processor, in communication with the one or more first storage devices and the one or more second storage devices, the computing device operative to:
obtain a request from a service customer for identification of content, the request indicating a group profile associated with the group of users wherein the service customer is distinct from the group of users wherein the group profile was created by the service customer without identifying individual users of the group of users, and wherein the group profile includes information provided by the service customer;
identify the group profile associated with the group;
automatically determine whether to add or remove a user from the group of users based on organizational criteria, wherein the organizational criteria include user online behavior;
in response to automatically determining to add or remove the user:
retrieve data related to a user profile associated with the user; and
update the group profile based at least in part on the data related to the user profile;
identify content based at least in part on the updated group profile;
obtain feedback from the service customer in response to the identified content; and
update the group profile based at least in part on the feedback.

16. The system of claim 15, wherein the group profile is defined at least in part by at least one of a content identification model, an organization criterion, device information, a billing configuration, a content preference, or a group restriction.

17. A non-transitory computer-readable storage medium storing computer-executable instructions that when executed by a processor perform operations comprising:
obtaining a request from a service customer for identification of content, the request indicating a group profile associated with a group of users defined by the request for the identification of content, wherein the service customer is distinct from the group of users, wherein the group profile was created by the service customer without identifying individual users of the group of users, and wherein the group profile includes information provided by the service customer;
automatically determining whether to add or remove a user from the group of users based on organizational criteria, wherein the organizational criteria include user online behavior;
in response to automatically determining to add or remove the user:
retrieving data related to a user profile associated with the user;
determining a group profile based at least in part on the data related to the user profile; and
causing the identification of content based at least in part on the determined group profile and feedback from the service customer.

18. The non-transitory computer-readable storage medium of claim 17, wherein causing the identification of content includes causing the identification of content with respect to the group of users.

19. The non-transitory computer-readable storage medium of claim 17, wherein causing the identification of content includes causing the identification of content with respect to at least one individual user of the group of users.

20. The non-transitory computer-readable storage medium of claim 17, the operations further comprising:
obtaining the feedback in response to the identified content; and
updating the group profile based at least in part on the feedback.
